(19) United States
(12) Patent Application Publication
(10) Pub. No.: US 2007/0205066 A1
(43) Pub. Date: Sep. 6, 2007

(54) Multimodular multistage high impact collision energy absorber

(76) Inventors: Sridharan Vinayagamurthy, Purasawalkam (IN); Ram Vairavan, Escondido, CA (US)

Correspondence Address: RAM VAIRAVAN, 1647, ANDORRE GLEN, ESCONDIDO., SAN DIEGO, CA, 92029, US

(21) Appl. No.: 11/367,344

(22) Filed: Mar. 6, 2006

(51) Int. Cl. F16F 7/12; B60R 19/26

(52) U.S. Cl. 188/376; 293/132

(57) ABSTRACT

This invention relates to a collision impact energy absorber that offers to absorb shock, impact and subsequent damage to vehicles in motion and other moving objects that require safety from impacts. This device fitted at appropriate impact zones of vehicles and crafts that move on and over land, air and water is capable of absorbing impacts of very high order and enhances the safety of lives and property. These can act in single units or in clusters where impacts of very high order are anticipated. The impact energy is directed into the hollow housing unit by a ram shaft that dislocates a series of vertically positioned sectional plates placed at intervals thereby absorbing the energy of the impacts on the host vehicle. This device is fitted as multimodular mode in tandem and also as multiple integrated modules to enhance its load dissipation efficiency.

### FIELD OF INVENTION

The present invention relates to a safety device in the form of an impact energy absorber resulting from collisions. The collisions and their impact on the host vehicles that move on land, sea and air result in deformation and damage to a very high degree resulting in loss of life, injury and loss of property. Automobiles on road and helicopters are prone to collision and crashes. The impact faces of these vehicles absorb the energy by undergoing deforming in relation to the magnitude of the impact and the accompanying momentum.

This device fitted alone, in pairs, clusters, in tandem units and in multiple series mode according to anticipated contingencies absorb the impact loads to a very large extent and thereby accords protection to life and property thereby reducing the likelihood of damage to the vehicle and its occupants.

Essentially, the following are the matters that will be considered in relation to this invention. They are firstly the operational or functional features of the device, and then there are the technical features, namely how the invention is implemented, how the invention is provided to the users, and finally, how the invention is handled by the manufactures and maintenance providers of vehicles their support agencies/service providers.

### BACKGROUND OF INVENTION WITH REGARD TO THE DRAWBACKS ASSOCIATED WITH KNOWN ART

Traditionally active, passive, vertical, lateral shock absorbers that are designed only for absorption of shock of very low order are the only defense against impacts of moving vehicles. Numerous instances in the past and present only goes to depict the inadequacy of these defense mechanisms against impact loads of very high order that occur when least expected. The suddenness with which collisions and impacts occur leaves little room for any active defense mechanisms to come into action in a meaningful way.

Many devices have been conceived to act with respect to absorption of collision energy such as impact bars, bumpers. These are designed to withstand collisions at very low speeds. Designing crumple zones to absorb energy work to some extent, but in the process of energy absorption there is a very extensive damage to the vehicle even from minor impacts and a relatively large area is crumpled.

This device dispenses the need to fabricate and position actuators during impact at the appropriate fraction of the moment. These actuators, sensors and other associated devices cost more and needs constant maintenance to keep them in working condition.

There are already a number of known methods for transferring large amount of kinetic energy that generates during a collision that is transferred to the chassis and other parts of the body of the colliding vehicle.

Some of the methods are hydraulic damping elements that dissipate kinetic energy to the vehicle. These systems are characterized by the high cost of manufacture and maintenance. They also occupy considerable space and weigh heavily.

Some conventional systems are deformation element, which deforms on impact and dissipates the collision impact energy. The disadvantage of these systems is that the dissipation characteristic remains the same, irrespective of the object with which collision occurs or the quantum of energy that is required to be dissipated.

The prior art of crumple zones, extra fenders, and a number of other modes and means of high energy impact absorption are plagued by inadequate, inconsistent and uneven deflection and absorption of impact resultant kinetic energy of very order and the protection afforded to the vehicles these method cover is so inadequate when compared to the total conflagration; the entire exercise becomes unworkable and unfeasible to be an effective tool and method.

It emerges from the prior art that the scope, methods of impact energy absorption and equipments are far too limited in their ability to 1) react according to the quantum of impact, 2) to dissipate sufficient kinetic energy efficiently 3) to occupy less space 4) to weigh in acceptable range, and in affordable manufacturing cost. The level of risk and danger the occupants are exposed in a fast moving vehicle during collision impacts of very high order in the processes and mechanism of prior art leaves much to be desired.

### OBJECT OF INVENTION

The object of the invention is to find a means of overcoming the multitude of shortcomings and handicaps the prior art is beseeched with. The rate of efficient dissipation, deflection of energy absorption of the impact load, of various methods that are in deployment is very far from satisfactory. The systems now in use at best play a damage-minimizing role during high impact collisions. It is not uncommon to find in spite of the presence of one or more of the prior art structures, vehicles damaged to a very high degree and deformed beyond recognition in several instances due to the inadequacy of the existing methods and devices.

This sectional shear dissipation method is a system by which the objective of near total and efficient absorption of kinetic energy that is generated during collision of vehicles. The absorption objective is fulfilled to a very large extent with the deployment of this system.

The object of the invention is to put a system in place in automobiles and other fast moving host vehicles, to instantly respond, a response commensurate with the impact loads, a device that occupies least space, weighs less and costs at affordable levels. The objective is also to ensure that these devices require minimum or no maintenance, no energy input to operate, and replaceable with ease and to work under all weather and terrain conditions.

### SUMMARY OF INVENTION

The multitude of disadvantages and inadequacies of prior art are overcome by the present invention whose principal object is to enhance the state of the art for absorption of kinetic energy that is generated by high impact collisions. This invention in particular facilitates effective deployment, instant response, and commensurate reaction to the impact loads that results on the vehicles this system is installed.

The operational/functional features of the device and method of the present invention contemplates installation of a tubular or cylindrical housing that is integrated with the chassis of the host vehicle. This cylindrical body is made of two equal halves that are fastened or welded according to requirements. An axial ramrod that has a buffer plate at one end and with a inner hammer face midway passes through the entire length of the cylinder at its axis. Fitted to the rod are sectional shear plates that are fixed to the grooves on the inner side of the cylindrical housing. The other end of the axial rod protrudes from the rear end of the housing. The sectional shear plates are held in place on the outer edge within the inner groove of the housing and in the center by the axial rod that passes through them.

The thickness of the plates and their metallic composition is determined by the anticipated impact loads on the host vehicle. The thickness of the cylindrical body is also decided accordingly. Fitted to the chassis and integrated with the host structure, the outer buffer plate is positioned just behind the bumpers of the vehicles where the impact would occur.

On a collision, the buffer plates behind the bumper of the host vehicle moves back into the cylindrical housing according to the velocity and momentum of the collision. The inner buffer plate then transfers the impact loads on to the outer convexity of the first of the sectional shear plate. This action in turn directs the force to be concentrated on the outer edges of the sectional shear plate on the shear groove. This shear groove facilitates shearing of the plates along the groove leaving the outer edge to remain in the inner groove of the cylindrical housing.

This process dissipates considerable energy as the shear happens only in response to an impact load of a high order. The sheared and dislocated first plate now impacts the second of the sectional plate being pushed on its rear by the axial ramrod. This process again results in the shear of the second of the shear plate from its groove and moves further inwards. If the ramrod transfers more energy the third plate is also displaced from its groove till all of the plates are displaced. This action effectively dissipates the impact load that resulted on the outer buffer plate of the axial ramrod.

The unique nature of this device is that it acts according to the quantum of impact load thereby affording a protection from damage to the host vehicle to a very large extent. The thickness of the shear groove and plates determine the point at which the shear occurs. This method and device thus overcomes many of the drawbacks inherent in existing systems that endeavor to fulfill the objective of adequate impact absorption.

### A BRIEF DESCRIPTION OF THE ACCOMPANYING DRAWINGS

A better understanding of the invention will be obtained by reference to the detailed description below, in conjunction with the following drawings in which:

FIG. 1 is a perspective view of the present invention, depicting in a schematic way the outer lateral view of the impact absorber, according to the preferred embodiment of the present invention,

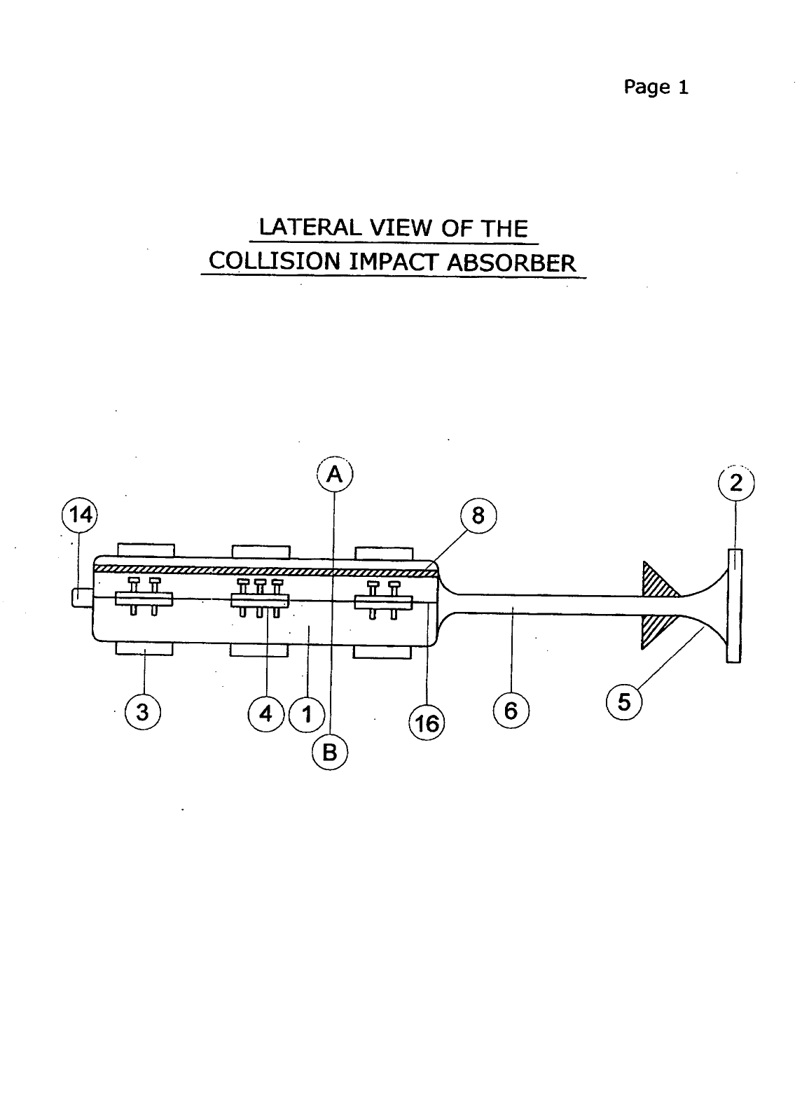

FIG. 2 is a perspective view of the present invention, depicting in a schematic way the frontal view of the impact absorber, according to the preferred embodiment of the present invention,

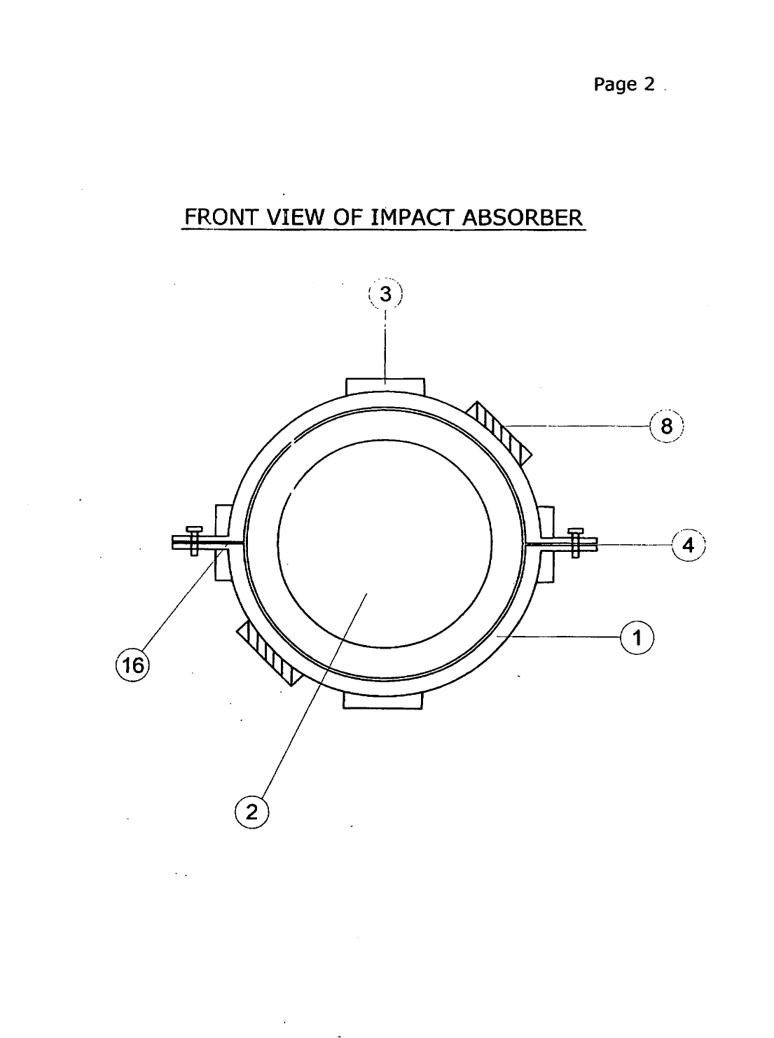

FIG. 3 is a perspective view of the present invention, depicting in a schematic way the rear view of the impact absorber, according to the preferred embodiment of the present invention,

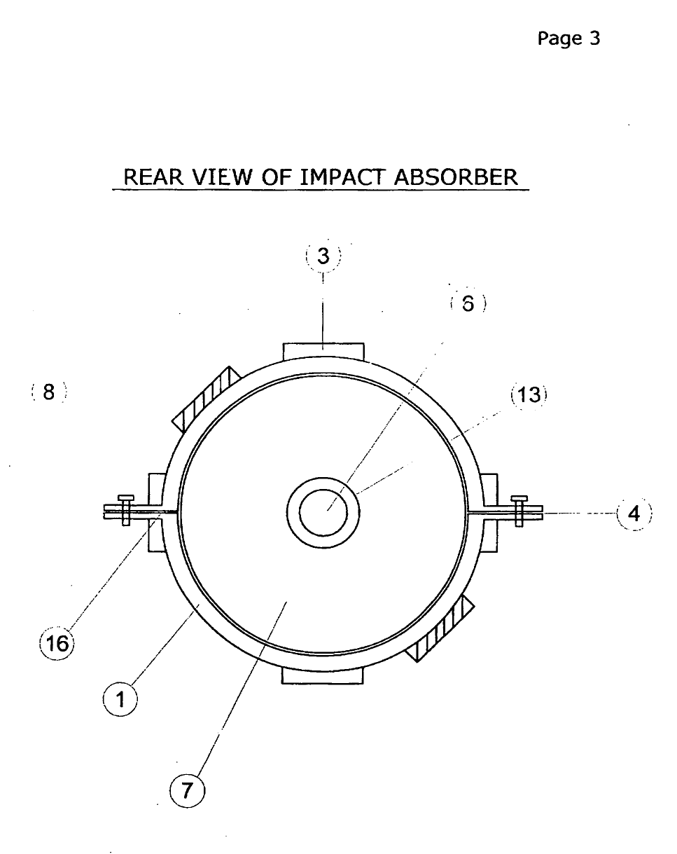

FIG. 4 is a cross-section at point A-B of FIG. 1 of the impact absorber, depicting the inner arrangement and positioning according to the preferred embodiment of the present invention.

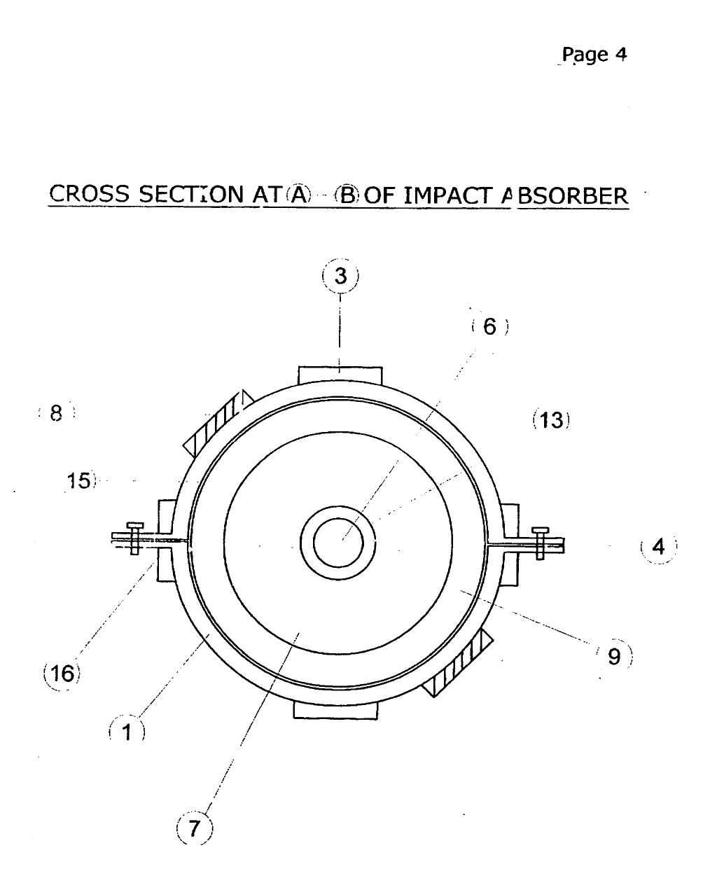

FIG. 5 is a lateral cross section of the impact absorber in normal mode and before impact on the outer buffer plate, depicting the inner arrangement of the projectile, the sectional shear plates and it's positioning according to the preferred embodiment of the present invention,

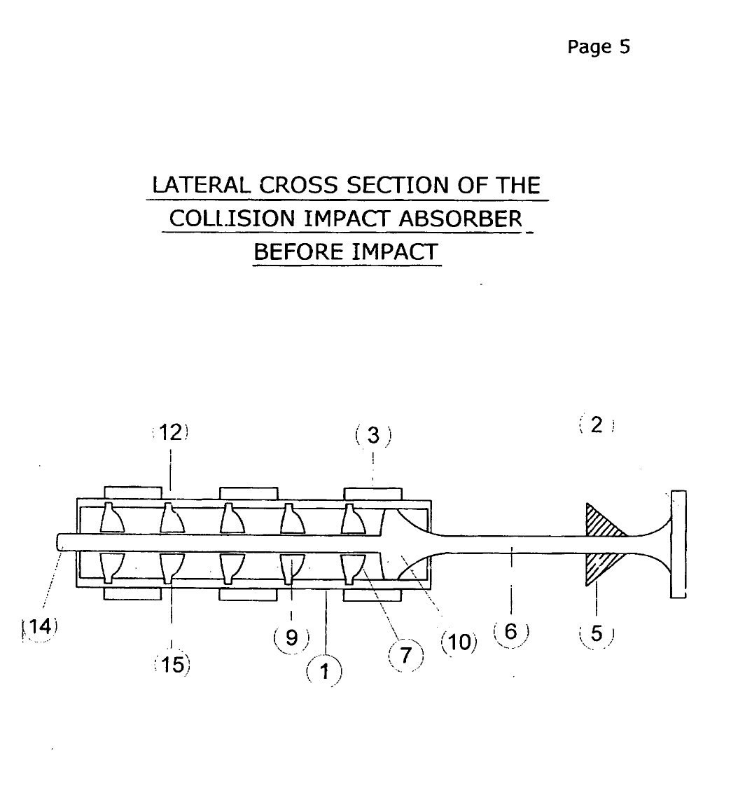

FIG. 6 is a perspective view illustrating the cross section of the collision impact absorber showing the displacement of the sectional shear plates to the rear of the cylindrical housing after the impact absorption, according to the preferred embodiment of the present invention

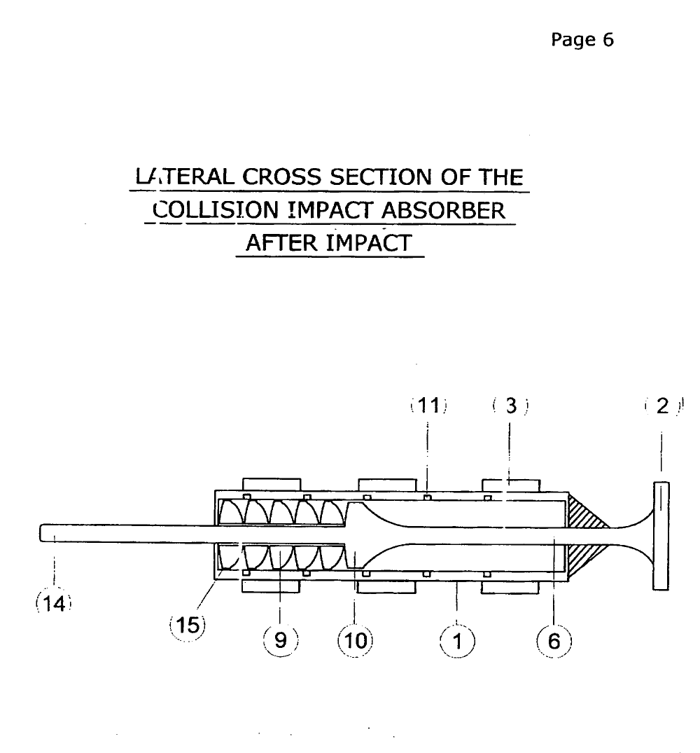

FIG. 7 is a perspective view illustrating a lateral view of the sectional shear plate, and the shear grooves and groove insert section, according to the preferred embodiment of the present invention,

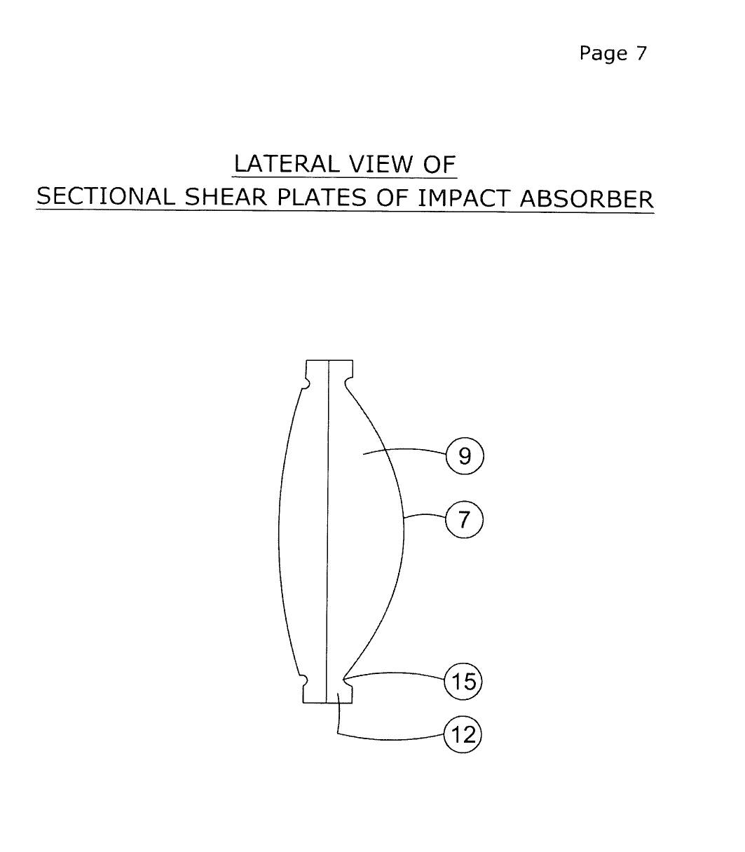

FIG. 8 is a perspective view illustrating the axial cross section of the sectional shear plates and the groove insert section of the impact absorber with the axial ram shaft running along the central convexity of the plates, according to the preferred embodiment of the present invention.

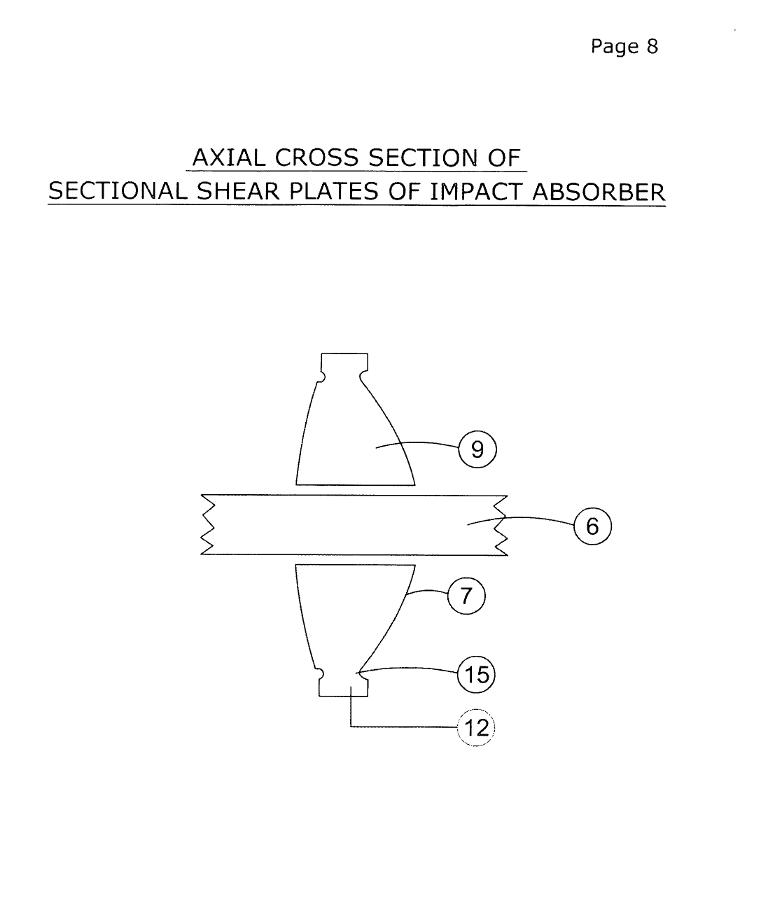

FIG. 9 is a perspective view illustrating the frontal view of the sectional shear plates and the groove insert section of the impact absorber with the a hole for axial ram shaft at the center and shear facilitation groove, according to the preferred embodiment of the present invention.

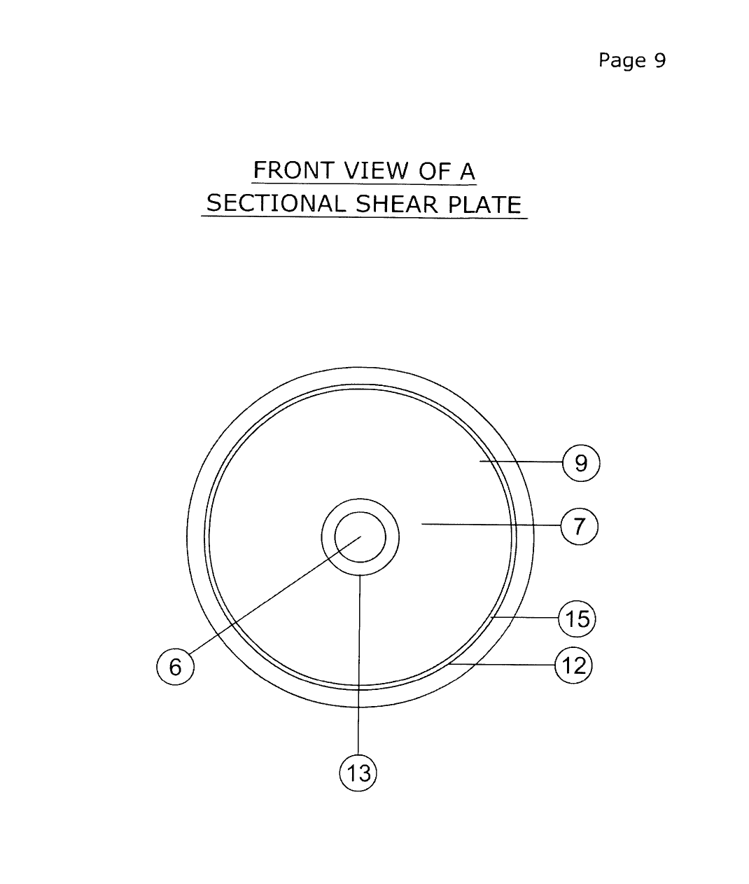

FIG. 10 is an illustration as to how the collision impact absorber is located and integrated in an automobile in a general way along the axis of the chassis, according to the preferred embodiment of the present invention.

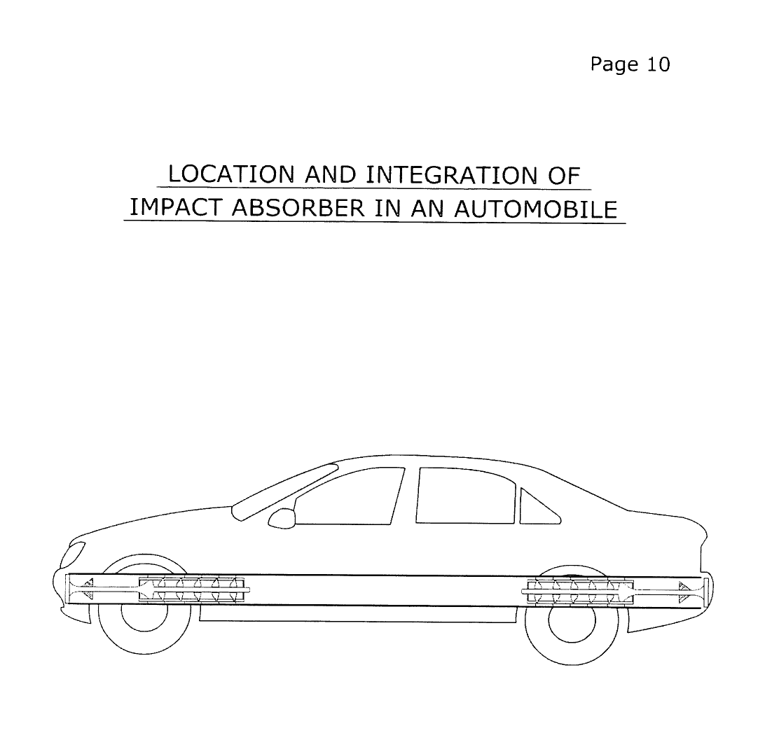

FIG. 11 is an illustration as to how the collision impact absorber is located and integrated with the airframe of a helicopter in a general way, according to the preferred embodiment of the present invention.

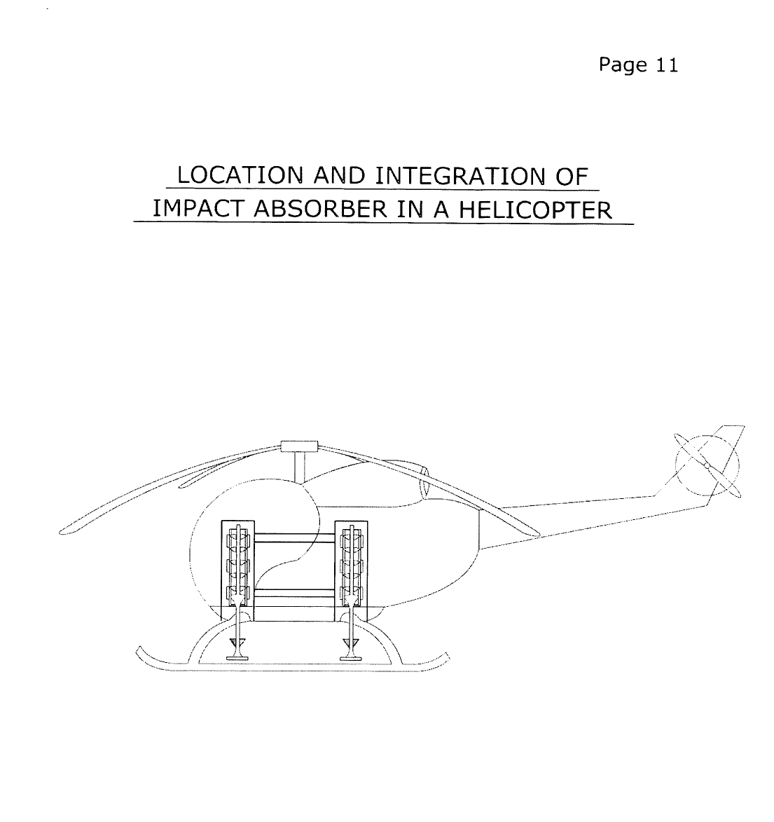

FIG. 12 is an illustration as to how the collision impact absorber is located and integrated with the chassis of a sports utility vehicle and in a rail coach along its chassis, according to the preferred embodiment of the present invention.

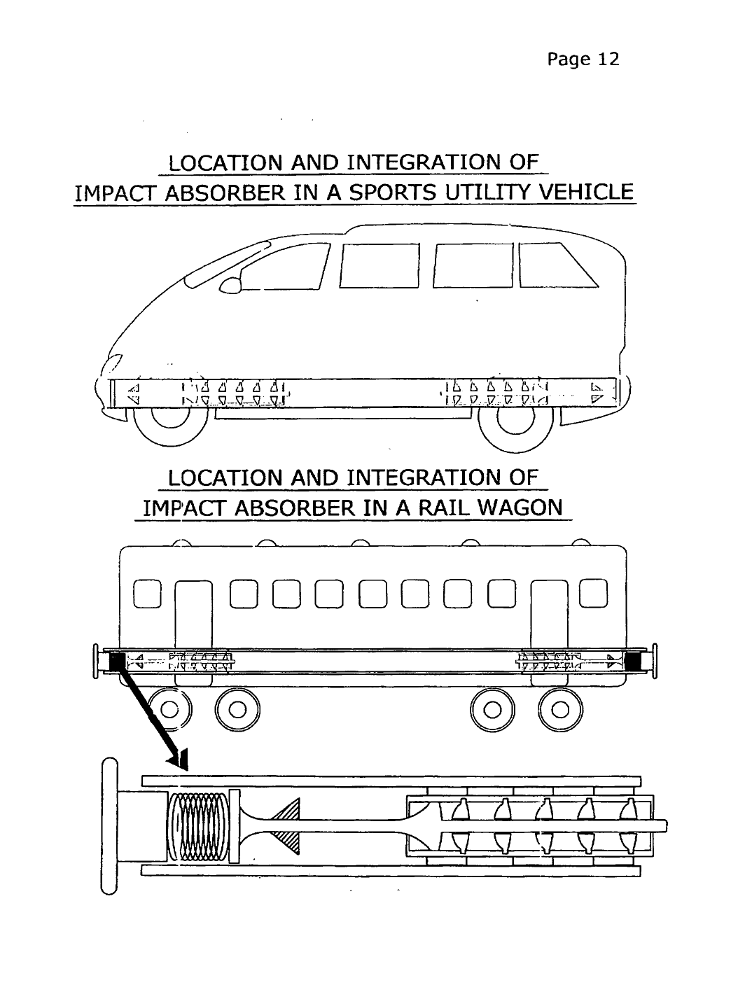

FIG. 13 is an illustration as to how the collision impact absorber is fitted as modules in tandem and as multiple integrated modules to achive an increased load dissipation capacity, according to the preferred embodiment of the present invention.

### DETAILED DESCRIPTION OF THE INVENTION WITH REFERENCE TO DRAWINGS AND PREFERRED EMBODIMENT

A preferred embodiment of the present invention, as well as objects, aspects, features and advantages, will be apparent and better understood from the following description in greater detail, of the illustrative and preferred embodiments thereof, which is to be read with reference to the accompanying drawings.

The accompanying drawings form a part of the specification, in which like numerals are employed to designate like parts of the same.

### The Device

The Main Cylindrical Metallic Housing

The device consists of a hollow cylindrical metallic tube 1 made of high tensile steel of adequate wall thickness. The front and back of the cylinder is fitted with a flange plate integrated with the cylinder 1. The flange plates at the front and rear have a hole to accommodate the ram shaft. The cylinder is made up of two equal and symmetrical sections with seams 16 along the axis that are fitted together with fasteners 4 to form the hollow cylinder.

The outer wall of the cylinder is welded and fastened with clamps 3 that facilitate its fitting and integration with the chassis of the host body. These clamps run along the axis to withstand axial dislocation during impact.

The inner wall of the cylinder has concentric grooves to hold sectional plates 9 perpendicular to the axis of the cylinder at intervals as determined by the possible impact loads, location and other application parameters.

On the outer wall of the main cylindrical body is a thickened strip 8 of the wall on the top and bottom. This thickened part is aligned with the face of the cutter 5 positioned behind the outer buffer plate. The parts are to be machined to high precision and near zero tolerance.

Sectional Shear Plates

The inner part of the hollow metallic cylinder is grooved in concentric circles at determined intervals. On these grooves are placed sectional shear plates 9. These sectional shear plates are metallic discs with a circular hole 13 to accommodate the ram shaft 6. The shear plates 9 have a circular groove 15 at the point of contact 12 with the inner wall of the cylinder. This groove on the rim of the shear plates on both the sides are to facilitate the shear of the plates at the desired location on the discs.

These shear plates are convex on both the sides. The fontal convexity 7 more pronounced than the rear convexity. The frontal convexity 7 is to transfer the impact force obtained on its body to the rim of the discs.

The thickness, convexity, metallic composition, depth of the shear groove, and all other parameters are determined by the anticipated impact loads. Material properties and characteristics of the sectional shear plates and the main cylindrical body is to be decided according to contingencies

Axial Ram Shaft

This crucial part is shaped in the form of a rod 6 with a buffer 2 or impact transfer disc on the front end. At a distance determined by the application this ram shaft has a convex inner buffer head 10 the convexity facing the first shear plate. This ram shaft 6 runs all along the axis of the cylinder and through all the shear plates 9 through the hole at their centers and protrudes at the rear end 14 of the cylinder.

This axial ram shaft 6 is of high tensile steel with a high resistance to bending. It is cast as a single pieces and machined to have the desirable shape. The parts are to be machined to high precision and near zero tolerance.

Assembling The Device

The main cylindrical body in two equal axial sections is opened and the sectional shear plates 9 are placed in their grooves. The two sections are fitted to form the cylindrical body with the fasteners. The ram shaft 6 is inserted into the cylinder and along the sectional shear plates till the other end of the shaft appears out side on the rear end. The inner buffer plate 10 is now facing the first of the sectional shear plate. The frontal convexity of the first plate and the rear convexity of the inner buffer plate now face each other. Now the front flange is place and locked. This places the axial ram shaft in position to take on the impact loads. This device is now fitted on to the host vehicle with fasterners3 at the strategic position and in the maximum impact zone.

Function

The outer fasteners 3 of the main body of the cylinder is tightened to a perfect and maximum fit. Now the outer impact buffer plate 2 is positioned at the rear of the front and back fenders or in other desirable locations. On an impact beyond the threshold magnitude, on the outer buffer plate, the impact force is conveyed along the shaft, it moves inward and causes the inner buffer plate facing the first of the sectional shear plates 9 to shear off the groove. If the impact is of a still higher order the second shear plate is also sheared and dislocated from its groove and this goes on till the last of the plate is sheared.

The first shear plate on shearing now acts as the inner buffer plate against the outer face of the second sectional plate. The rear convexity of the first sectional plate forces against the outer convexity of the second shear plate and so on. All through this motion the plates are held in place by the ram shaft section that runs through the axial hole in the center of the sectional plates. The left over rim 11 of the sectional shear plates remain in the inner grooves of the housing cylinder.

The radius of the convexity of the axial ram shaft inner face that faces the first of the sectional shear plate 9 and the subsequent rear convex faces of the sectional shear plates act to enhance the transfer of the impact loads and its energy towards the shear grooves of the sectional shear plates towards dislocating them thereby dissipating and absorbing the impact energy transferred by the axial ram shaft. The dominant concept is the shear resistance against force and dissipation and absorption of the impact load by the shearing of the sectional shear plates along the shear groove and along axis of the cylinder.

The rear end of the ram shaft now appears outside the rear flange to the extent of the impact and depending upon the extent of penetration of the shaft and number of sectional shear plates that have been shorn off their grooves. If the impact goes beyond the estimated load level the rear flange also gives way taking up some impact energy and a sharp cutter face 5 located on top and bottom of the shaft cuts through the thickened cylindrical wall 8 dissipating the extra impact energy. The outer ring 11 of the sectional shear plate is left in the inner grooves of the cylindrical housing, as the sheared plates are dislocated and moves to the rear inside the main cylindrical unit. The sequential intervals of the sectional shear plates 9 enhance the energy absorption, as each one is hit with a force from a small distance form each other.

This method of sequential shear of the sectional shear plates is far superior in absorbing and dissipating the tremendous force applied on them in stages. The passengers will be subjected to only a sharp high frequency vibration for a very very small time span lasting only a second or its fraction. The thickness of the plates, the sequential thickness, the gap between the plates, and combination of various thickness of the sectional plates can absorb impacts of any magnitude imparting a great deal of protection to the superstructure from deforming and collapsing thereby exposing the passengers to injuries.

To enhance the accuracy of the axial ram shaft 6 to instantly start the transfer of the impact load on to the sectional shear plates 9 and its grooves the thickness of the first sectional shear plate is made lesser than other plates so that the ram shaft is directed at the desired angle into the main body in instances where the impact is at an angle on the outer buffer plate.

This method capitalizes on the high resistance to axial shear of metals and alloys and combinations and when the shear occurs it takes up a massive quantum of impact energy. In event of the impact load being more than the anticipated levels and the impact is such that the last of the sectional shear plates also is sheared, the residual energy is absorbed when the cutter face behind the outer buffer plate starts shearing the main body itself on the thickened portion of the outer cylindrical body of the impact absorber housing.

Multiple Modules In Tandem And Multiple Integrated Modules

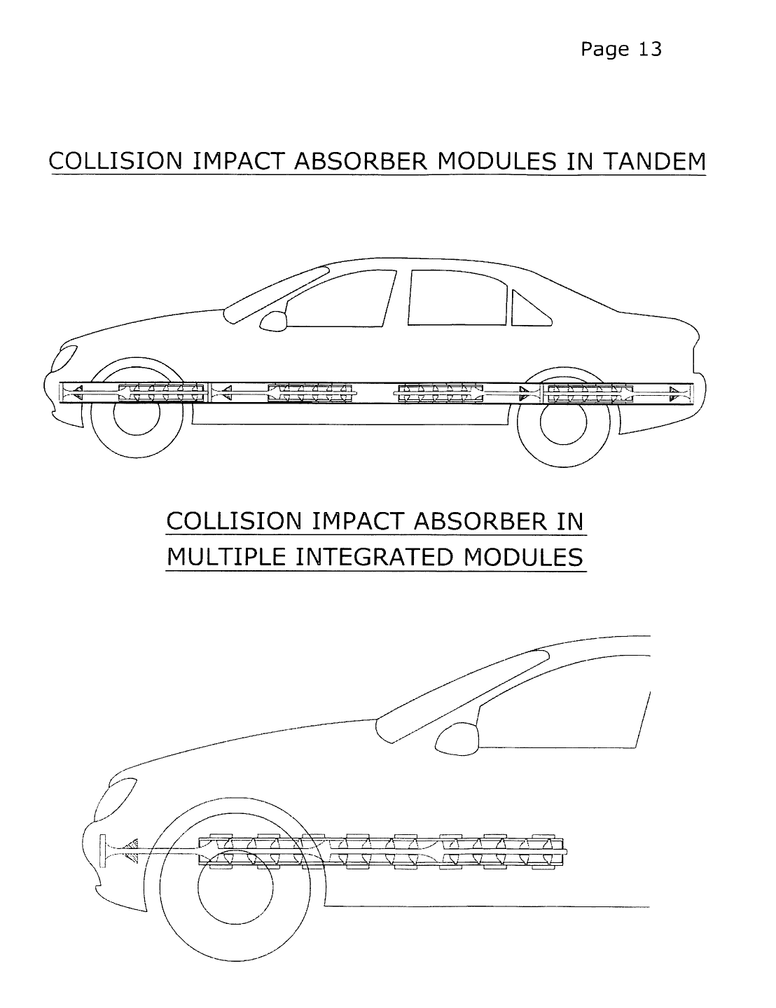

In the event the host chassis and bumper design not permitting adequate space for the absorber unit and its positioning behind the bumper, the outer aesthetics of the vehicle not permitting deviation, the absorber units can be positioned in tandem one behind the other or multiple modules are integrated as a single linear unit with the inner buffer plate placed at determined intervals between the shear plates FIG. 13.

In instances like these the positioning is done in such a way FIG. 13 the rear end of the shaft is fitted with a buffer plate that faces the outer buffer plate of the second unit in close contact. This arrangement achieves the advantage of shearing double the number of shear plates for the same displacement distance of the axial rod on impact. Even for a very short inward movement of the axial rod double the number or more of shear plates can be sheared and dislocated, thereby achieving a higher quantum of impact load absorption and also not having to make the sectional shear plates too thick in the forward unit which may offer extra resistance to shear thereby increasing the possibility of non absorption of the impact that would be transferred to the host vehicle. This method is also helpful to maintain the aesthetics of vehicle design and dispenses with the need to have a long protruding axial shaft beyond the front and back fenders to achieve higher impact absorption levels.

Customizing

The entire structure of the shock absorber is easily amenable to customizing according to the requirement of the host vehicle. This is achieved by modifying the metallurgical composition of the sectional shear plates, increasing or decreasing the thickness of the plates, increasing or decreasing the depth of the groove of the sectional shear plates and the thickness of the shear grooves 15 that is lodged in the corresponding grooves in the housing cylinder. The distance between shear plates and their varying thickness imparts different impact load absorption properties.

All combinations of the shear plates and their thickness, starting with thin plates and increasing the thickness gradually of the rear plates would offer protection in particular situations and having the first shear plate as the thickest and a decreasing thickness of the rear plates would offer protection in different way according to the anticipated impact loads. The impact absorption units can be fitted in clusters can be fitted in tandem units or in multiple integrated modular mode depending on the anticipated impact loads and protection levels needed.

Positioning

The impact absorber device is located and fitted to the chassis of the host vehicle along the axis of the chassis. The outer buffer plate is placed just behind the outer cover, or front and back fenders as the case may be. The integration of this device with the chassis should be done with adequate fasteners 3 and welded if needed in anticipation of higher impact loads.

These devices can be fitted to the rail wagons just behind the buffer plates. The buffer plates that act on the springs located behind them can be modified to connect them with the axial ram shaft. The cylindrical body of the device would be fitted along the inner superstructure.

Replacement

Consequent to an impact of low order the shear plate that has been dislocated can be replaced with a new disc after removing the outer rim that remains in the inner groove of the main cylinder by opening the two halves of the cylinder. If all the sectional shear plates are sheared off their grooves a replacement is possible in the same way as above. This replacement can be carried out with least down time. If the impact is of such high magnitude so as to shear all the plates and also to tear the thickened wall portion of the cylindrical wall by the cutter face the whole of the assembly is to be replaced on the chassis.

Maintenance

The maintenance requirement of this device after fitting on to the host vehicle would be very negligible as there are no moving parts when not in use, no wear and tear under normal use conditions.

While the invention has been described in several preferred embodiments, it is to be understood that the words, which have been used, are words of description rather than words of limitation and that changes within the purview of the basis of the above device and method may be made without departing from the scope and spirit of the invention in its broader aspect.

Although the present invention has been described herein before and illustrated in the accompanying drawings, with reference to a particular embodiment thereof but it is to be understood that the present invention is not limited thereto but covers all embodiments of the improved collision impact absorber which would fall within the ambit and scope of the present invention as would be apparent to a man in the art.

The foregoing description of the preferred embodiment has been presented for purposes of illustration and description. It is not intended to be exhaustive nor to limit the invention to the precise form disclosed, and many modifications and variations are possible in light of the above teaching. The embodiments were chosen and described to best explain the principles of the invention and its practical application.

While the foregoing description makes reference to particular illustrative embodiments, these examples should not be construed as limitations. Not only can the inventive device system be modified for using it in different application areas, but modifications of the structure is possible to customize for any kind of moving object that requires protection from damage resulting from impacts in any direction or with any object. Thus, the present invention is not limited to the disclosed embodiments, but is to be accorded the widest scope consistent with the claims below.

List of Reference Numerals.

| Reference Numeral | Corresponding name of the part |
|---|---|
| 1 | Absorber housing |
| 2 | Outer buffer plate of the ram shaft |
| 3 | Host body integrator clamp |
| 4 | Absorber housing fasteners |
| 5 | Axial ram shaft cutter face |
| 6 | Axial ram shaft |
| 7 | Sectional shear face convexity |
| 8 | Housing cutter zone |
| 9 | Sectional shear plate |
| 10 | Inner ram shaft buffer head |
| 11 | After shear ring |

Having thus described our invention, what I claim as new and desire to secure by Letters Patent is as follows:

1. A multistage collision impact absorber device in the form of a longitudinal cylindrical housing made up of two equal parts that are fitted together to form a cylindrical housing; with concentric grooves at regular or irregular intervals at the inner wall of the cylinder to accommodate a series of metallic convex plates designated as sectional shear plates, perpendicular to the wall of the cylinder; with a flange cover at both ends of the cylinder; with a strip of thickened layer of the housing wall running along the length at the top and bottom in alignment with the cutter face of the axial shaft; with fasteners that clamp the two halves of the body together and with clamps that integrate the housing with the chassis of the host body; fixed to the inner wall grooves are a series of sectional shear plates that are placed perpendicular to the axis of the cylindrical housing that have a hole in their center, with convexities at both sides and a fragmentation facilitation grooves at the edge of plate on both sides where the plates meet the groove; the outer rim outside the shear grooves remaining inside the inner positioning grooves of the cylindrical body; an axial ram shaft with a outer buffer plate and an inner buffer ram head with convexity that faces the first sectional shear plate inside the housing; the shaft of the ram rod running along the length of the housing passing through the central hole of every sectional shear plates to the rear end of the housing; this shaft also has a cutter plate that is aligned to the thickened outer layers of the cylindrical housing; on impact the outer buffer plate of the axial ram shaft transfers the impact load by moving inwards; this movement causing the inner buffer head of the ram shaft colliding with the first of the sectional shear plate causing it to dislocate from the inner groove of the housing and move towards the second shear plate which in turn impacted by both the inner buffer head as well as the first of the dislocated shear plate; the second shear plate is dislocated by this motion and moves on to the third plate and so on till the last of the shear plates are dislocated leaving behind the outer rim of the sectional shear plates to remain in the inner groove of the cylinder; the impact load of the collision being dissipated in the process of shearing the series of sectional shear plates; the device fitted to anticipated collision impact regions as an extension of the basic structural frame of the host vehicle and integrated with it.

2. The collision impact absorber device of claim 1 where the entire mechanism is housed inside a cylindrical metallic housing that is integrated with the host vehicle with fasteners and other methods.

3. The collision impact absorber device of claim 1 where the cylindrical metallic housing has concentric grooves at regular determined intervals at its inner wall.

4. The collision impact absorber device of claim 1 where the concentric grooves are fitted with a series of sectional shear plates where the outer rim of the plates are firmly positioned inside the grooves.

5. The collision impact absorber of claim 1 where the sectional shear plates are convex at both sides and have a shear facilitation groove at the outer rim and a hole at the center.

6. The collision impact absorber of claim 1 where the axial ram shaft that has an outer buffer plate and an inner convex buffer plate to transfer the impact load on to the sectional shear plates.

7. The collision impact absorber of claim 1 where the axial ram shaft runs along the entire length of the housing through the holes in the center of the sectional shear plates.

8. The collision impact absorber device of claim 1 where axial ram shaft has a cutter plate fitted behind the outer buffer plate facing the cylindrical housing.

9. The collision impact absorber device of claim 1 where a strip of hardened metal is implanted or forged along with the cylindrical housing aligned along with the cutter face.

10. The collision impact absorber device of claim 1 where a row of fasteners clamp together the two equal halves of the metallic cylindrical housing after the sectional shear plates and the axial ram shaft is placed inside.

11. The collision impact absorber device of claim 1 where a impact load results on the outer buffer plate the axial ram shaft transfers the load on to the series of sectional shear plates.

12. The collision impact absorber device of claim 1 where the transferred impact by the axial ram shaft on to the sectional shear plates causes them to shear along the shear facilitation grooves at their outer rim leaving the shorn outer rim to remain in the inner concentric grooves of the metallic housing.

13. The collision impact absorber device of claim 1 where the thickened layer of metallic strip is torn by the cutter face as an additional impact dissipation measure after all the sectional shear plates are shorn of their grooves.

14. The collision impact absorber device of claim 1 where the housing units can be placed in tandem along the chassis with the axial ram shafts aligned to transfer the impact loads on to more than one series of sectional shear plates to effect increased load absorption capacity.

15. The collision impact absorber device of claim 1 where the metallic cylindrical housing can be made as a extended module where more than one set of sectional shear plates are placed with inner buffer plates fitted at desired intervals in between the sets of shear plates to achieve increased load absorption capacity.
